(19) United States
(12) Patent Application Publication
(10) Pub. No.: US 2026/0153068 A1
(43) Pub. Date: Jun. 4, 2026

(54) RESONATOR-INTEGRATED DUCT AND METHOD FOR MANUFACTURING RESONATOR- INTEGRATED DUCT

(71) Applicant: ISUZU MOTORS LIMITED, Yokohama-shi (JP)

(72) Inventors: Tomohiro NAGASE, Fujisawa-shi (JP); Kazuhisa FUKUDA, Fujisawa-shi (JP)

(21) Appl. No.: 19/344,202

(22) Filed: Sep. 29, 2025

(30) Foreign Application Priority Data
Nov. 29, 2024 (JP) 2024-207988

(51) Int. Cl. F02M 35/12

(52) U.S. Cl. CPC F02M 35/1266; F02M 35/1261; F02M 35/1283

(57) ABSTRACT

A resonator-integrated duct includes: a duct portion through which intake air flows, and a resonator chamber integrally formed with the duct portion and in contact with the duct portion so that an outer wall of the duct portion serves as a partition wall. The resonator chamber includes a plurality of opening portions and respectively having an opening and an opening that penetrate through an outer wall of the resonator chamber, a communication hole that is formed, on the partition wall, at a position facing the opening of the one opening portion and that communicates with the duct portion, and a plurality of lid members that close the openings of the plurality of opening portions.

### CROSS-REFERENCE TO RELATED APPLICATIONS

The present application claims priority to Japanese Patent Application number 2024-207988, filed on Nov. 29, 2024 contents of which are incorporated herein by reference in their entirety.

### BACKGROUND OF THE INVENTION

The present disclosure relates to a resonator-integrated duct and a method for manufacturing the resonator-integrated duct. Utility Model Application Publication No. H3-83364 discloses a structure of an intake duct integrally formed with a resonator chamber, where a communication hole is formed in the partition wall between the duct portion and the resonator chamber. A cover is attached to the resonator chamber to close one opening portion through which a core (sand mold inserted into the mold) is withdrawn during casting.

Normally, a support portion is provided in the core, which is inserted through the opening portion, and the operation of pouring molten metal into the mold is performed while supporting the support portion. However, in the above-described structure, since there is only one opening portion, only a single support portion can be provided, resulting in unstable support of the core by the support portion. In such a case, shifts in the core's position within the mold may cause deterioration in the quality of the cast product, namely, a resonator-integrated duct.

### BRIEF SUMMARY OF THE INVENTION

The present disclosure has been made in view of these points, and its object is to provide a structure capable of suppressing deterioration in quality during forming of a resonator-integrated duct.

A first aspect of the present disclosure provides a resonator-integrated duct including: a duct portion through which intake air flows; and a resonator chamber integrally formed with the duct portion 24 and in contact with the duct portion so that an outer wall of the duct portion serves as a partition wall, wherein the resonator chamber includes: a plurality of opening portions each having an opening that penetrates through an outer wall of the resonator chamber; a communication hole that is formed, on the partition wall, at a position facing an opening of one opening portion of the plurality of opening portions and that communicates with the duct portion; and a plurality of lid members that close the openings of the plurality of opening portions.

A second aspect of the present disclosure provides a method for manufacturing a resonator-integrated duct, the method including: a first step of forming a casting in which a duct portion having a first cavity and a resonator chamber having a second cavity are integrally formed with a partition wall interposed therebetween; a second step of removing a core that fills the second cavity through openings of a plurality of opening portions that penetrate an outer wall of the resonator chamber of the casting; a third step of inserting a tool through an opening of one opening portion of the plurality of opening portions, and forming a communication hole in the partition wall at a position facing the opening of the one opening portion, the communication hole connecting the resonator chamber and the duct portion; and a fourth step of closing the openings of the plurality of opening portions with lid members.

### BRIEF DESCRIPTION OF THE DRAWINGS

FIG. 1 is a schematic diagram illustrating a configuration of an intake apparatus 1 according to an embodiment.

FIG. 2 is a schematic diagram showing an external configuration of a resonator-integrated duct 14.

FIG. 3 is a schematic view showing an internal configuration of the resonator-integrated duct 14.

FIG. 4 is a flowchart showing a flow of manufacturing a resonator-integrated duct.

FIG. 5 is a schematic view for explaining a casting that has been produced.

FIG. 6 is a schematic view for explaining machining of a communication hole 36.

### DETAILED DESCRIPTION OF THE INVENTION

Hereinafter, the present disclosure will be described through exemplary embodiments, but the following exemplary embodiments do not limit the invention according to the claims, and not all of the combinations of features described in the exemplary embodiments are necessarily essential to the solution means of the invention.

### Overview of an Air Intake Apparatus

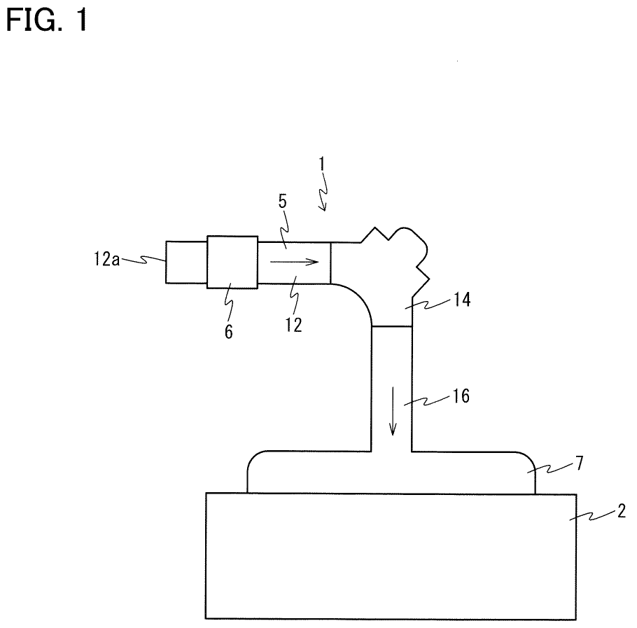

FIG. 1 is a schematic diagram illustrating a configuration of an intake apparatus 1 according to one embodiment. The intake apparatus 1 is mounted in a vehicle, for example, and supplies intake air to an engine 2. As shown in FIG. 1, the intake apparatus 1 includes an intake pipe 5, an air cleaner 6, and an intake manifold 7.

The intake pipe 5 is a passage through which intake air flows to the engine 2. The intake pipe 5 is coupled to the intake manifold 7. The intake pipe 5 includes an upstream duct 12, a resonator-integrated duct 14, and a downstream duct 16. Although not shown in FIG. 1, a supercharger compressor may be provided in the intake pipe 5.

The upstream duct 12 is a duct with an intake port 12a for drawing in intake air. The upstream duct 12 is coupled to the upstream end of the resonator-integrated duct 14. The intake air drawn in through the intake port 12a flows through the upstream duct 12 and into the resonator-integrated duct 14.

The resonator-integrated duct 14 is an intermediate duct located between the upstream duct 12 and the downstream duct 16. The resonator-integrated duct 14 is coupled to the upstream duct 12 and the downstream duct 16, and intake air flowing through the resonator-integrated duct 14 flows into the downstream duct 16.

The resonator-integrated duct 14 of the present embodiment has a structure in which a duct portion and a resonator chamber are integrated. The resonator chamber reduces high-frequency noise generated during intake. The sound energy entering the resonator chamber is converted into thermal energy by friction, thereby reducing noise at specific frequencies. The detailed configuration of the resonator-integrated duct 14 will be described later.

The downstream duct 16 is located downstream of the resonator-integrated duct 14. The downstream duct 16 is coupled to the intake manifold 7, and intake air flowing through the downstream duct 16 flows into the intake manifold 7.

The air cleaner 6 is provided in the intake pipe 5 and functions to purify the intake air. The air cleaner 6 removes fine dust (such as debris or similar particles) in the intake air. The air cleaner 6 is provided in the upstream duct 12 of the intake pipe 5.

The intake manifold 7 is coupled to the downstream duct 16 of the intake pipe 5. The intake manifold 7 is a branched pipe that distributes the intake air, which has flowed in from the intake pipe 5, to each of a plurality of cylinders of the engine 2.

### Detailed Configuration of the Resonator-Integrated Duct

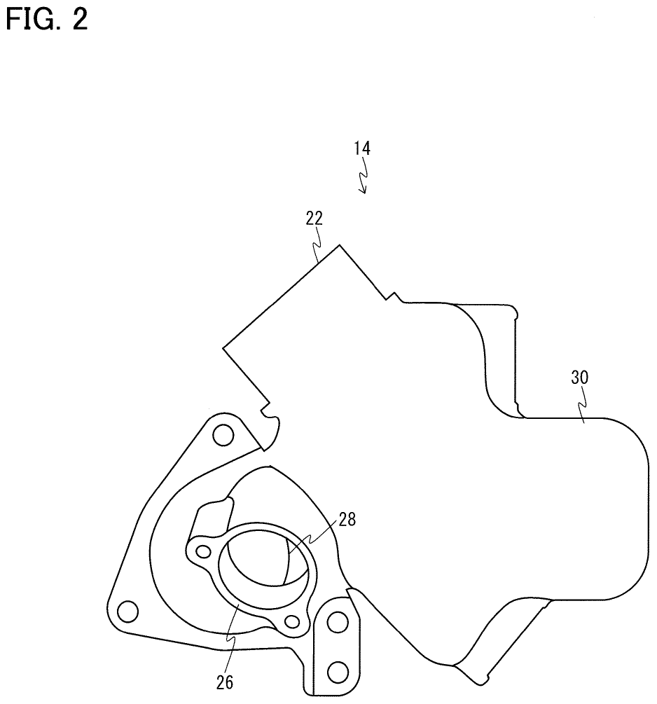

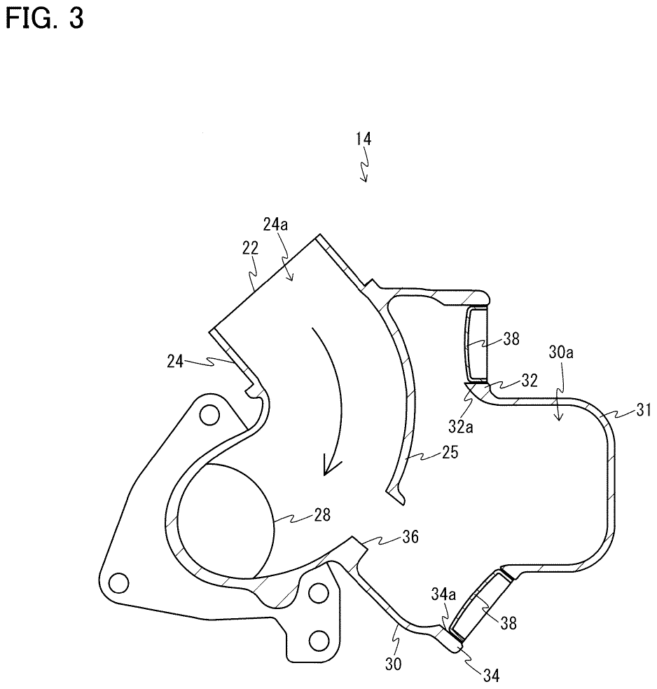

FIG. 2 is a schematic view showing an external configuration of the resonator-integrated duct 14. FIG. 3 is a schematic view showing an internal configuration of the resonator-integrated duct 14. FIG. 3 is a cross-sectional view of the resonator-integrated duct 14, taken in a plane parallel to the plane of FIG. 2.

As shown in FIGS. 2 and 3, the resonator-integrated duct 14 includes an inflow portion 22, a duct portion 24, a blow-by gas return portion 26, an outflow portion 28, and a resonator chamber 30. The inflow portion 22 has an opening through which intake air flows in. The inflow portion 22 is coupled to the upstream duct 12. The intake air flowing through the upstream duct 12 flows into the duct portion 24 via the inflow portion 22.

The duct portion 24 forms a flow path through which the intake air that has entered from the inflow portion 22 flows. The duct portion 24 is a tubular member having a cavity (hereinafter referred to as a first cavity 24a) on the inside, through which the intake air flows. The duct portion 24 is made of metal. The intake air within the duct portion 24 flows toward the outflow portion 28. As shown in FIG. 3, the duct portion 24 does not form a straight flow path, but instead forms a curved flow path. The duct portion 24 is curved from the upstream side, where the intake air enters, toward the downstream side.

The outflow portion 28 has an opening through which the intake air flows out. The outflow portion 28 is coupled to the downstream duct 16. The intake air that has flowed through the duct portion 24 flows out from the outflow portion 28 into the downstream duct 16.

The return portion 26 has an opening through which blow-by gas from the engine 2 is recirculated back into the duct portion 24. The recirculated blow-by gas flows out from the outflow portion 28 into the downstream duct 16 together with the intake air that has flowed through the upstream duct 12. The blow-by gas is combustion gas that leaks into the crankcase through gaps such as those in the piston rings of the engine 2 or in the turbocharger.

The resonator chamber 30 silences intake sound through a resonance effect based on Helmholtz theory. Here, the intake sound refers to high-frequency noise generated during the intake process. According to Helmholtz theory, when air is introduced through an air hole provided in a resonance chamber, the air within the resonance chamber resonates at a specific frequency (resonance frequency). A resonator using this phenomenon can cancel noise corresponding to the resonance frequency via the resonance effect. Here, the resonance frequency generated in the resonance chamber is determined on the basis of the length (in other words, depth) and cross-sectional area of the air hole, and the volume of the resonance chamber. Specifically, the resonance frequency increases as the cross-sectional area of the air hole increases, and decreases as the length of the air hole and the volume of the resonance chamber increase. In the present embodiment, the resonator chamber 30 functions as the resonance chamber, and a communication hole 36 functions as the air hole. A cavity (hereinafter referred to as a second cavity 30a) is formed inside the resonator chamber 30. The resonator chamber 30 is in communication with the duct portion 24 via the communication hole 36 (see FIG. 3). Specifically, the second cavity 30a communicates with the first cavity 24a via the communication hole 36. According to Helmholtz theory, the resonance frequency increases with an increase in the cross-sectional area of the communication hole 36, and decreases with an increase in the length and the volume of the communication hole 36.

The resonator chamber 30 is made of metal and integrally formed with the duct portion 24. Specifically, the metal resonator chamber 30 and the duct portion 24 are integrally formed by casting. When the resonator chamber 30 and the duct portion 24 are integrated in this manner, there is no need to couple the resonator chamber 30 and the duct portion 24 using a coupling member or the like.

As shown in FIG. 3, the resonator chamber 30 is provided in the duct portion 24 in such a way that the outer wall of the duct portion 24 serves as a partition wall 25. The partition wall 25 is a wall-like member that separates the resonator chamber 30 from the duct portion 24. In the present embodiment, the duct portion 24 is curved from the upstream side toward the downstream side. The resonator chamber 30 is provided on the duct portion 24 such that the outer wall of the duct portion 24, curved at a predetermined curvature, serves as the partition wall 25. Accordingly, the partition wall 25 separating the resonator chamber 30 and the duct portion 24 also serves as part of the outer wall of the resonator chamber 30. Therefore, no gap is formed between the resonator chamber 30 and the duct portion 24. As a result, the volume of the resonator chamber 30 can be increased.

As shown in FIG. 3, the resonator chamber 30 includes an outer wall 31, the communication hole 36, and a lid member 38. The outer wall 31 of the resonator chamber 30 has a first opening portion 32. The outer wall 31 is a wall that faces the partition wall 25. The outer wall 31 is connected to the duct portion 24 by a side wall (see FIG. 2). Therefore, the partition wall 25, the outer wall 31, and the side wall together form the resonator chamber 30. The first opening portion 32 has a first opening 32a that penetrates the outer wall 31. In this embodiment, the first opening 32a is a circular through hole. More specifically, the first opening 32a is a through hole having a circular inner peripheral surface. The first opening 32a serves as an outlet for removing the core (specifically, sand forming the core) that fills the second cavity 30a during manufacturing of the resonator.

The outer wall 31 of the resonator chamber 30 has a second opening portion 34. The second opening portion 34 has a second opening 34a that penetrates the outer wall 31. The second opening 34a is a circular through hole. More specifically, the second opening 34a is a through hole having a circular inner peripheral surface. The outer wall 31 has a second opening 34a at a position different from that of the first opening 32a. The outer wall 31 has the first opening 32a at a position facing an upstream portion of the partition wall 25, and the second opening 34a at a position facing a downstream portion of the partition wall 25. The second opening 34a serves as an outlet for removing the core that fills the second cavity 30a during manufacturing of the resonator. In the present embodiment, as shown in FIG. 3, the outer wall 31 has the first opening 32a and the second opening 34a at positions spaced apart from each other in the flow direction of the intake air flowing through the duct portion 24. As a result, the core filling the second cavity 30a can be efficiently removed. In addition, in the present embodiment, the outer wall 31 of the resonator chamber 30 has two openings. However, the embodiment is not limited thereto, and may have three or more openings.

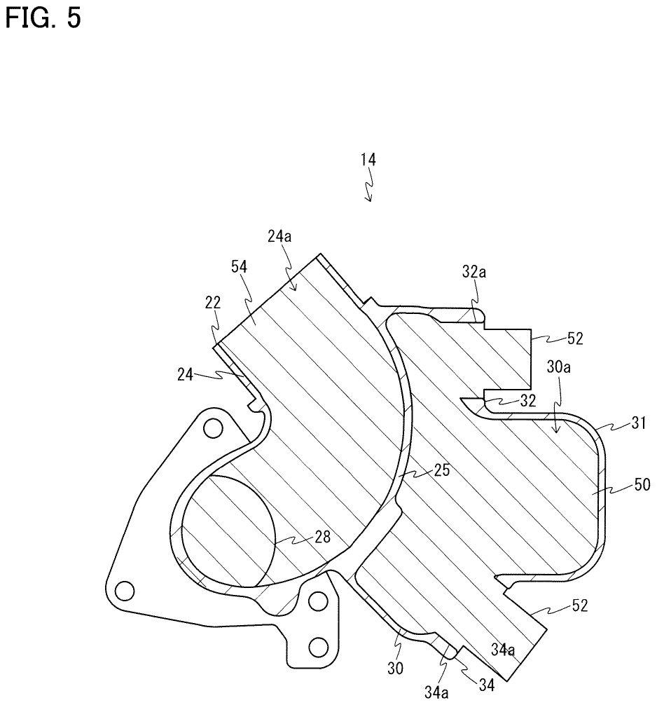

As described above, when the resonator chamber 30 is manufactured together with the duct portion 24 by casting, a core is used in a portion corresponding to the cavity of the resonator chamber 30. The core includes a support portion (support portion 52 shown in FIG. 5) that supports the core when molten metal for forming the resonator-integrated duct 14 is poured into the mold. When the resonator chamber 30 has a plurality of opening portions (the first opening portion 32 and the second opening portion 34) as in the present embodiment, the core may include a plurality of support portions configured to be coupled to the core via the first opening portion 32 and the second opening portion 34. In this case, by supporting the core with the plurality of support portions, it is possible to suppress floating or rotation of the core when molten metal is poured into the mold, thereby reducing the likelihood of positional deviation of the core during casting.

Since the first opening portion 32 and the second opening portion 34 are spaced apart from each other on the outer wall 31, the core can be more stably supported. Furthermore, when a plurality of opening portions are provided at arbitrary positions on the outer wall 31, the degree of freedom in designing the external shape of the resonator chamber 30 increases compared to the case where a single opening portion having a large opening is provided. As a result, it becomes easier to increase the volume of the resonator chamber 30. At this time, the smaller the openings included in the plurality of opening portions, the greater the degree of freedom in the external shape of the resonator chamber 30. In the present embodiment, the diameters of the inner peripheral surfaces of the openings of the plurality of opening portions and the diameters of the outer peripheral surfaces of the lid members 38 are smaller than the diameter of the duct portion 24.

The communication hole 36 is a through hole that penetrates the partition wall 25, and communicates the duct portion 24 with the resonator chamber 30. In this way, the duct portion 24 and the resonator chamber 30 can communicate with each other without providing a communicating member. When the through hole of the partition wall 25 is the communication hole 36, the length (in other words, depth) of the communication hole 36 can be determined by adjusting the thickness of the partition wall 25. In the present embodiment, the communication hole 36 is circular. When the communication hole 36 is circular, the cross-sectional area can be determined by adjusting the diameter of the communication hole 36.

The communication hole 36 is formed, on the partition wall 25, at a position facing the second opening 34a of the second opening portion 34. On the other hand, no communication hole 36 is formed on the partition wall 25 at a position facing the first opening 32a of the first opening portion 32. As described above, the communication hole 36 is formed, on the partition wall 25, at a position facing the second opening 34a, which is an opening provided in one of the plurality of opening portions of the outer wall 31 of the resonator chamber 30.

The communication hole 36 is formed in the downstream portion of the partition wall 25, which is curved from the upstream side toward the downstream side. By forming the communication hole 36 in the downstream portion of the partition wall 25 that curves from the upstream side to the downstream side in this manner, it is possible to suppress the intake air flowing through the duct portion 24 from passing through the communication hole 36 and entering the resonator chamber 30. As a result, the intake air can be appropriately supplied to the engine 2.

The diameter of the communication hole 36 is smaller than the diameter of the second opening 34a of the second opening portion 34. For example, the diameter of the communication hole 36 is one-half to two-thirds the diameter of the second opening 34a. As will be described later, the communication hole 36 is formed by machining, using a tool (such as a drill) inserted through the second opening 34a. Therefore, by making the diameter of the communication hole 36 smaller than the diameter of the second opening 34a, the tool can be more easily inserted through the second opening 34a, allowing for smoother machining of the communication hole 36.

The lid members 38 close the first opening 32a of the first opening portion 32 and the second opening 34a of the second opening portion 34. One lid member 38 is press-fitted into each of the first opening portion 32 and the second opening portion 34. The outer peripheral surface of the lid member 38 that fits into the first opening 32a has the same shape as the inner peripheral surface of the first opening 32a. More specifically, the outer peripheral surface of the lid member 38 that fits into the first opening 32a has a circular shape in the same manner as the inner peripheral surface of the first opening 32a. Furthermore, in this example, the lid member 38 that closes the first opening 32a has the same shape as the lid member 38 that closes the second opening 34a. As a result, two small lid members 38 can be used, which helps reduce manufacturing costs compared to using one large lid member. It should be noted that the shapes of the two lid members 38 are not limited to being identical and may differ.

### Manufacturing Flow of the Resonator-Integrated Duct

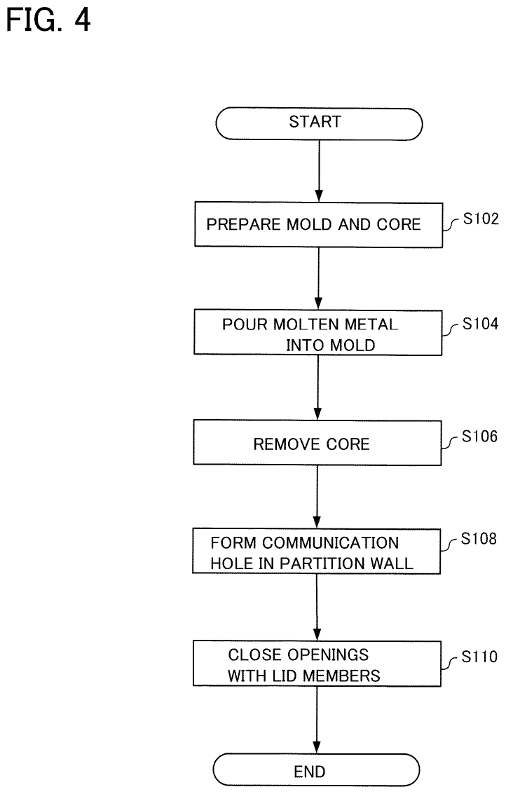

FIG. 4 is a flowchart showing a flow of manufacturing the resonator-integrated duct.

First, an operator prepares a mold and a core (step S102). Here, the mold consists of an upper mold and a lower mold. The core includes a first core that fills the first cavity 24a of the duct portion 24 and a second core that fills the second cavity 30a of the resonator chamber 30. For example, the operator sets the core into the lower mold and then sets the upper mold.

Next, the operator pours molten metal, in which metal is melted, into the mold prepared in step S102 (step S104). When the temperature of the poured molten metal decreases, the molten metal solidifies, and a casting is formed. When the molten metal is poured into the mold, the core is supported by the two support portions 52 of a core 50 shown in FIG. 5. The two support portions 52 are fitted to the mold. Supporting the core 50 with the two support portions 52 in this manner stabilizes its position within the mold and suppresses floating and rotation of the core inside the mold.

FIG. 5 is a schematic view for explaining a casting that has been produced. In FIG. 5, the casting is shown with the mold removed. The produced casting is an integral structure in which the duct portion 24 having the first cavity 24a and the resonator chamber 30 having the second cavity 30a are formed as one unit with the partition wall 25 interposed between them. Here, it is assumed that a core 54 (first core) remains in the first cavity 24a, and the core 50 (second core) remains in the second cavity 30a. The support portions 52 of the core 50 are inserted through the first opening 32a and the second opening 34a, respectively. In FIG. 5, the support portions of the core 54 are omitted for convenience of description.

Next, the operator removes the core 50, which fills the second cavity 30a of the resonator chamber 30, through the first opening 32a and the second opening 34a in the outer wall 31 of the resonator chamber 30 of the casting (step S106). For example, the operator may apply vibration to the sand-made core 50 to break it apart, and discharges the sand through the first opening 32a and the second opening 34a. At this time, the operator also removes the core 54, which fills the first cavity 24a of the duct portion 24. Specifically, the operator breaks apart the core 54, which fills the first cavity 24a, and removes the core 54 through the openings of the inflow portion 22, outflow portion 28, and return portion 26.

Next, the operator forms a communication hole 36 in the partition wall 25 between the duct portion 24 and the resonator chamber 30 (step S108). Specifically, the operator forms the communication hole 36 at a position on the partition wall 25 facing the second opening 34a, thereby allowing the resonator chamber 30 and the duct portion 24 to communicate with each other. In this way, even if the duct portion 24 and the resonator chamber 30 are integrally molded, the communication hole 36 can be formed through the second opening 34a.

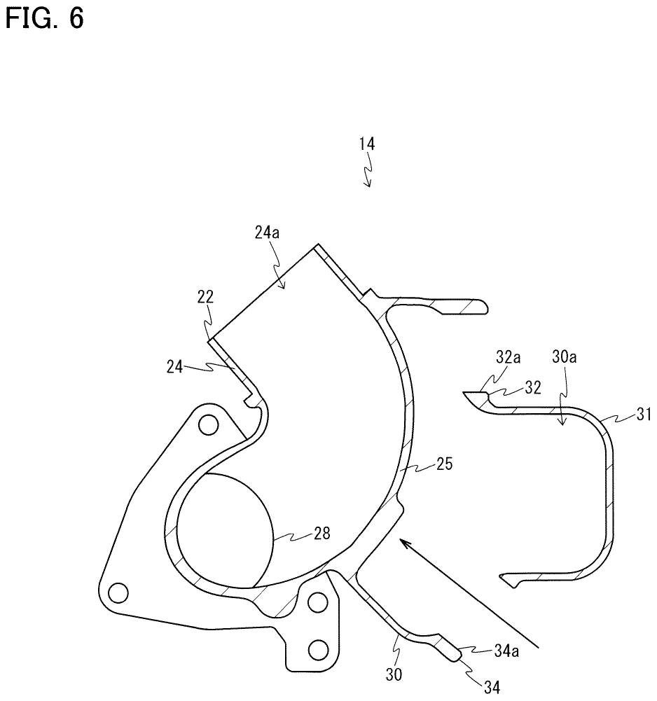

FIG. 6 is a schematic view for explaining the formation of the communication hole 36. The operator inserts a tool (e.g., a drill) into the second cavity 30a through the second opening 34a in the direction indicated by the arrow. Then, using the inserted tool, the operator machines a predetermined location on the partition wall 25 to form the communication hole 36 (see FIG. 3). Specifically, the operator machines the partition wall 25 using a tool inserted in a straight direction so as to form the communication hole 36 with a diameter smaller than that of the second opening 34a. In this manner, when the communication hole 36 is formed using a tool rather than during casting, the communication hole 36 can be formed with high accuracy at a desired position on the partition wall 25 and with a desired diameter.

Next, the operator closes the first opening 32a and the second opening 34a with the lid members 38 (step S110). For example, the operator closes each of the first opening 32a and the second opening 34a by press-fitting the lid members 38 (see FIG. 3).

Thus, the resonator-integrated duct 14 is completed. It should be noted that Step S104 shown in FIG. 4 corresponds to a first process, step S106 corresponds to a second process, step S108 corresponds to a third process, and step S110 corresponds to a fourth process.

### Effects of the Embodiment

The resonator-integrated duct 14 of the above-described embodiment includes the resonator chamber 30 that is in contact with the duct portion 24 such that the outer wall of the duct portion 24 serves as the partition wall 25. The resonator chamber 30 includes: a plurality of opening portions (the first opening portion 32 and the second opening portion 34), each having an opening that penetrates through the outer wall 31; the communication hole 36 that is formed in the partition wall 25 at a position facing the second opening 34a of the second opening portion 34 and communicating with the duct portion 24; and a plurality of lid members 38 that close the first opening 32a and the second opening 34a. In the case of the above configuration, two support portions 52 of the core 50 can be provided so as to be inserted through the first opening portion 32 and the second opening portion 34 when the resonator-integrated duct 14 is manufactured. In this manner, since the two support portions 52 support the core 50, it is possible to suppress floating or rotation of the core 50 when molten metal is poured into the mold, and thus the position of the core 50 is less likely to fluctuate. Furthermore, since the communication hole 36 is formed at a position facing the second opening 34a on the partition wall 25, the communication hole 36 can be easily machined through the second opening 34a, and the communication hole 36 can be formed with high accuracy. As a result, it is possible to realize a structure capable of easily and highly accurately manufacturing the resonator-integrated duct 14.

The present disclosure is explained based on the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

What is claimed is:

1. A resonator-integrated duct comprising:
a duct portion through which intake air flows; and
a resonator chamber integrally formed with the duct portion 24 and in contact with the duct portion so that an outer wall of the duct portion serves as a partition wall, wherein the resonator chamber includes:
a plurality of opening portions each having an opening that penetrates through an outer wall of the resonator chamber;
a communication hole that is formed, on the partition wall, at a position facing an opening of one opening portion of the plurality of opening portions and that communicates with the duct portion; and
a plurality of lid members that close the openings of the plurality of opening portions.

2. The resonator-integrated duct according to claim 1, wherein the duct portion is curved from an upstream side, where the intake air enters, toward a downstream side, the resonator chamber is provided on the duct portion so that the curved outer wall of the duct portion serves as the partition wall, and the communication hole is formed in a downstream portion of the partition wall.

3. The resonator-integrated duct according to claim 1, wherein the openings of the plurality of opening portions are spaced apart from each other in the outer wall of the resonator chamber.

4. The resonator-integrated duct according to claim 1, wherein inner peripheral surfaces of the openings of the plurality of opening portions have the same shape, and outer peripheral surfaces of the plurality of lid members, which fit into the openings of the plurality of opening portions, have the same shape.

5. The resonator-integrated duct according to claim 4, wherein the inner peripheral surfaces are circular, and the outer peripheral surfaces are circular.

6. The resonator-integrated duct according to claim 1, wherein inner peripheral surfaces of openings of the plurality of opening portions, and outer peripheral surfaces of the plurality of lid members that are fitted into each of the respective openings, are circular, and diameters of the inner peripheral surfaces and the outer peripheral surfaces are smaller than a diameter of the duct portion.

7. The resonator-integrated duct according to claim 1, wherein a diameter of the communication hole is smaller than a diameter of the opening of one of the opening portions.

8. A method for manufacturing a resonator-integrated duct, the method comprising:
a first step of forming a casting in which a duct portion having a first cavity and a resonator chamber having a second cavity are integrally formed with a partition wall interposed therebetween;
a second step of removing a core that fills the second cavity through openings of a plurality of opening portions that penetrate an outer wall of the resonator chamber of the casting;
a third step of inserting a tool through an opening of one opening portion of the plurality of opening portions, and forming a communication hole in the partition wall at a position facing the opening of the one opening portion, the communication hole connecting the resonator chamber and the duct portion; and
a fourth step of closing the openings of the plurality of opening portions with lid members.

9. The method for manufacturing the resonator-integrated duct according to claim 8, wherein, in the third step, the partition wall is machined with a tool inserted straight through the opening of the one opening portion, so as to form the communication hole having a diameter smaller than a diameter of the opening.
